(19) United States
(12) Patent Application Publication
(10) Pub. No.: US 2017/0337593 A1
(43) Pub. Date: Nov. 23, 2017

(54) METHOD TO RECOMMEND AN AUTO SHOP TO AN AUTOMOBILE USER

(71) Applicant: Vincent S. TONG, Philadelphia, PA (US)

(72) Inventor: Vincent S. TONG, Philadelphia, PA (US)

(21) Appl. No.: 15/158,615

(22) Filed: May 19, 2016

(51) Int. Cl. G06Q 30/02; G06F 17/30; G07C 5/00

(52) U.S. Cl. CPC G06Q 30/0282; G07C 5/008; G06F 17/30867; G06Q 30/0278

(57) ABSTRACT

A method executed by a computer system recommend an auto shop to an automobile user. The method includes receiving an event data for an automobile at a server in a computer system; analyzing the event data to select different auto shops to contact in order to service the automobile by the server; contacting computers of the auto shops to obtain service information; analyzing the service information for each of the auto shops by the server; generating a recommendation as to one of the auto shops to provide the services on the automobile by the server; and providing the recommendation as to one of the auto shops to provide the services on the automobile by the server to a handheld portable electronic device (HPED) of the automobile user.

### FIELD OF THE INVENTION

The present invention relates to a method to recommend an auto shop to an automobile user and a computer system therefor.

### BACKGROUND

Cars often need to be serviced at a regular interval or after a collision. A car owner, however, may not know what kind of service is needed or which auto shop can perform the service or repairs.

In view of the demand for car service, improvements in systems and methods that provide auto shop recommendations are desired.

### BRIEF DESCRIPTION OF THE DRAWINGS

FIG. 1 shows a computer system to recommend an auto shop to an automobile user in accordance with an example embodiment.

FIG. 2 shows a method of providing a recommendation of an auto shop to an automobile user in accordance with an example embodiment.

FIG. 3 shows a method of regular exam on an automobile initiated by a server in accordance with an example embodiment.

FIG. 4 shows a method of communicating with an auto shop upon a car accident in accordance with an example embodiment.

FIG. 5 shows a method of providing a recommendation of an auto shop to a handheld portable electronic device (HPED) upon a car accident in accordance with an example embodiment.

FIG. 6 shows a display of a HPED in accordance with an example embodiment.

### SUMMARY OF THE INVENTION

One example embodiment is a method executed by a computer system that recommends an auto shop to an automobile user. The method includes receiving event data for an automobile at a server in a computer system; analyzing the event data to select different auto shops to contact in order to service the automobile; contacting computers of the auto shops to obtain service information; analyzing the service information for each of the auto shops; generating a recommendation as to one of the auto shops to provide the services on the automobile; and providing the recommendation as to one of the auto shops to provide the services on the automobile.

Other example embodiments are discussed herein.

### DETAILED DESCRIPTION

Example embodiments relate to system and method to provide a recommendation of an auto shop to an automobile user.

Car users may have a couple of familiar auto shops that they use for performing regular and periodical maintenance on their cars. However, if they encounter an accident in travelling in a different city, or even in a different part of the city, they may not have the information of the nearest auto shop, or an auto shop with a better reputation readily available. Example embodiments solve these problems and other problems and provide a system and a method to recommend an auto shop to an automobile user.

In one example embodiment of the method, a server in the computer system receives event data for an automobile, in which the event data includes services to be performed on the automobile. The server analyzes the event data to select different auto shops to contact in order to service the automobile, and contacts computers of the auto shops to obtain service information. This service information includes, but is not limited to, a cost to perform the services on the automobile and an available time to perform the services on the automobile. The server analyzes the cost to perform the services and the available time to perform the services for each of the auto shops and based on this information, generates a recommendation as to one of the auto shops to provide the services on the automobile. A recommendation as to one of the auto shops to provide the services on the automobile, provided by the server, is sent to the automobile user, such as sending the recommendation to an automobile of the user, a computer to which the user has access, or a handheld portable electronic device (HPED) of the automobile user.

One example embodiment includes a method executed by a car maintenance system to provide a recommendation to a car user. Position data and event data that includes a service to be performed on the car are received by a server in the car maintenance system and from the car. The server transmits the event data to a plurality of auto shops, and receives from the auto shops service data that includes, but is not limited to, a price to perform the service on the car. The server ranks the auto shops based on an analysis of the service data, and provides the car user with a recommendation of one of the auto shops based on the ranking of the auto shops. A confirmation of the recommendation of the one of the auto shops is received by the server. The server schedules the car for servicing at the one of the auto shop confirmed by the car user.

In one example embodiment, an image of the car is captured with a HPED. Object recognition determines that the image is an image of the car, and this image of the car is transmitted to the server by the HPED.

In an example embodiment, the server retrieves historical service records about the car from a database, and transmits the event data and the historical service records to the auto shops.

In one example embodiment, the server determines a time when the car is involved in a collision, and sends a reminder to take a photograph of the car after a predetermined amount of time elapses from the time when the car is involved in the collision.

In an example embodiment, the event data includes a problem code that is generated from a sensor in the car.

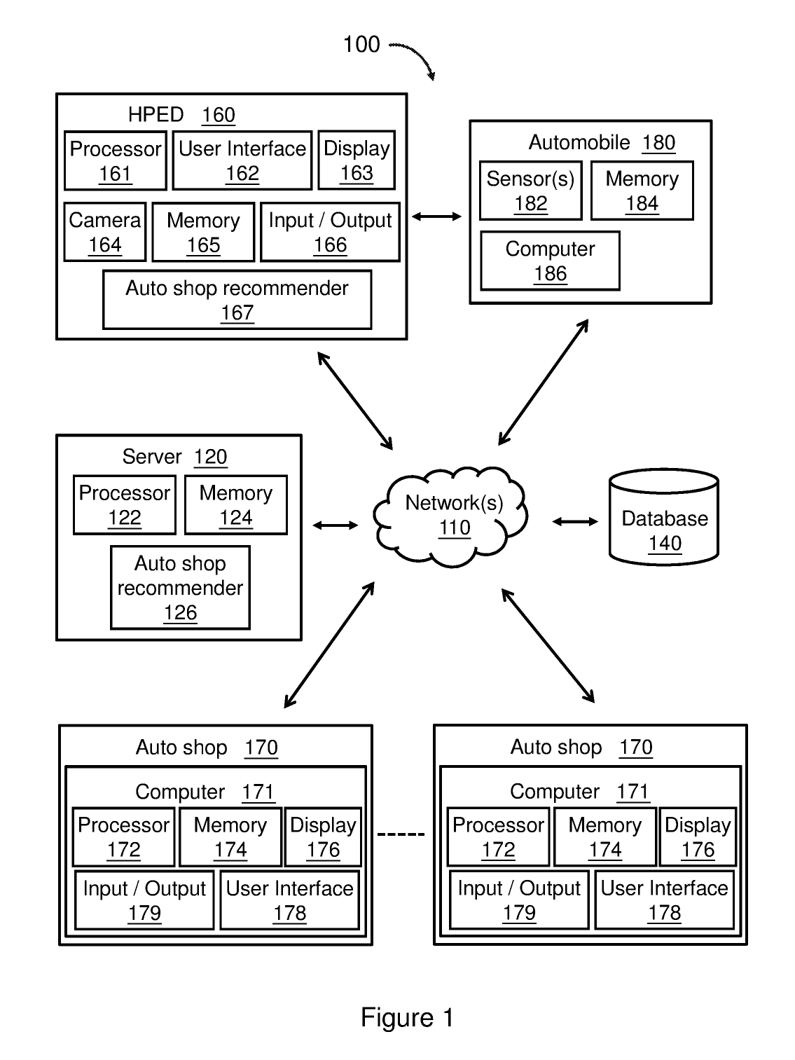

FIG. 1 shows a computer system 100 to recommend an auto shop to an automobile user in accordance with an example embodiment. The computer system 100 includes a server 120, a database 140, a handheld portable electronic device (HPED) 160, one or more auto shops 170, and an automobile 180. One or more elements in the computer system 100 can communicate with each other through one or more networks 110.

The networks 110 can include one or more of the internet, an intranet, an extranet, a cellular network, a local area network (LAN), a home area network (HAN), metropolitan area network (MAN), a wide area network (WAN), a Bluetooth network, public and private networks, etc.

The server 120 includes a processor 122 that communicates with a memory 124 and an auto shop recommender 126. By way of example, the processor 122 can be a microprocessor, central processing unit (CPU), or application-specific integrated circuit (ASIC) for controlling and/or receiving instructions or data from the memory 124 (such as random access memory (RAM), read only memory (ROM), and/or firmware).

By way of example, the auto shop recommender 126 receives diagnostic data of the damage to the automobile 180 from the HPED 160, transmits the diagnostic data of the damage from the automobile 180 to plural auto shops 170, receives estimates to repair the automobile 180 from the auto shops 170, analyzes the estimates to generate a recommendation as to which of the auto shops 170 to select to repair the automobile 180, and transmits the recommendation to the HPED 160.

In one example embodiment, the auto shop recommender 126 receives photographs of the automobile from the HPED 160, executes object recognition on the photographs to determine a make, a model, and a year of the automobile 180, and compares the make, the model, and the year of the automobile 180 to stored owner data to verify an owner of the automobile 180.

By way of example, the auto shop recommender 126 generates ranks of the auto shops 170 according to distance from the automobile, price to repair the automobile, length of time to repair the automobile, and a start date to repair the automobile. The auto shop recommender 126 provides the ranks to the HPED 160 or another electronic device.

In one example embodiment, the auto shop recommender 126 transmits a reminder to the HPED 160 to take photographs of the automobile 180 after the collision.

In another example embodiment, the auto shop recommender 126 scores the auto shops 170 and provides the scores to the HPED 160 with the recommendation. The HPED 160 receives the recommendation and displays a list of the auto shops 170 in a priority according to the scores.

The HPED 160 (such as a smartphone, a tablet computer, a laptop, or other computer) can include a processor 161, a user interface 162, a display 163, a camera 164, a memory 165, an input/output (I/O) 166, and an auto shop recommender 167.

By way of example, the processor 161 can be a microprocessor, central processing unit (CPU), or application-specific integrated circuit (ASIC) for controlling and/or receiving instructions or data from the memory 165 (such as random access memory (RAM), read only memory (ROM), and/or firmware). The memory 165 stores the information such as diagnostic data of the damage to the automobile 180, and recommendation provided by the auto shop recommender 126.

In an example embodiment, the user interface 162 displays diagnostic data of the damage (such as photos taken by the camera 164) and the recommendation, and enables a user to communicate with the computer system 100. The display 163 displays information, such as the diagnostic data of the damage and the recommendation. By way of example, the auto shop recommender 167 of the HPED 160 communicates with the auto shop recommender 126 of the server 120 in transmitting information such as the diagnostic data of the damage and the recommendation between the HPED 160 and the server 120.

By way of example, the auto shop 170 can include a computer 171 that includes a processor 172, a memory 174, a display 176, a user interface 178, and an input/output (I/O) 179. The processor 172 can be a microprocessor, central processing unit (CPU), or application-specific integrated circuit (ASIC) for controlling and/or receiving instructions or data from the memory 174 (such as random access memory (RAM), read only memory (ROM), and/or firmware). By way of example, the processor 172 can provide service data that includes a price to perform the service upon receiving the diagnostic data of the damage, and an available time to perform the services. In an example embodiment, the display 176 displays information such as the diagnostic data of the damage.

The automobile 180 includes one or more sensors 182 that detect an impact when the automobile 180 is in a collision, a computer 186 that determines the diagnostic data of damage to the automobile 180 after the sensor(s) 182 detects the collision, and a memory 184 that stores the diagnostic data.

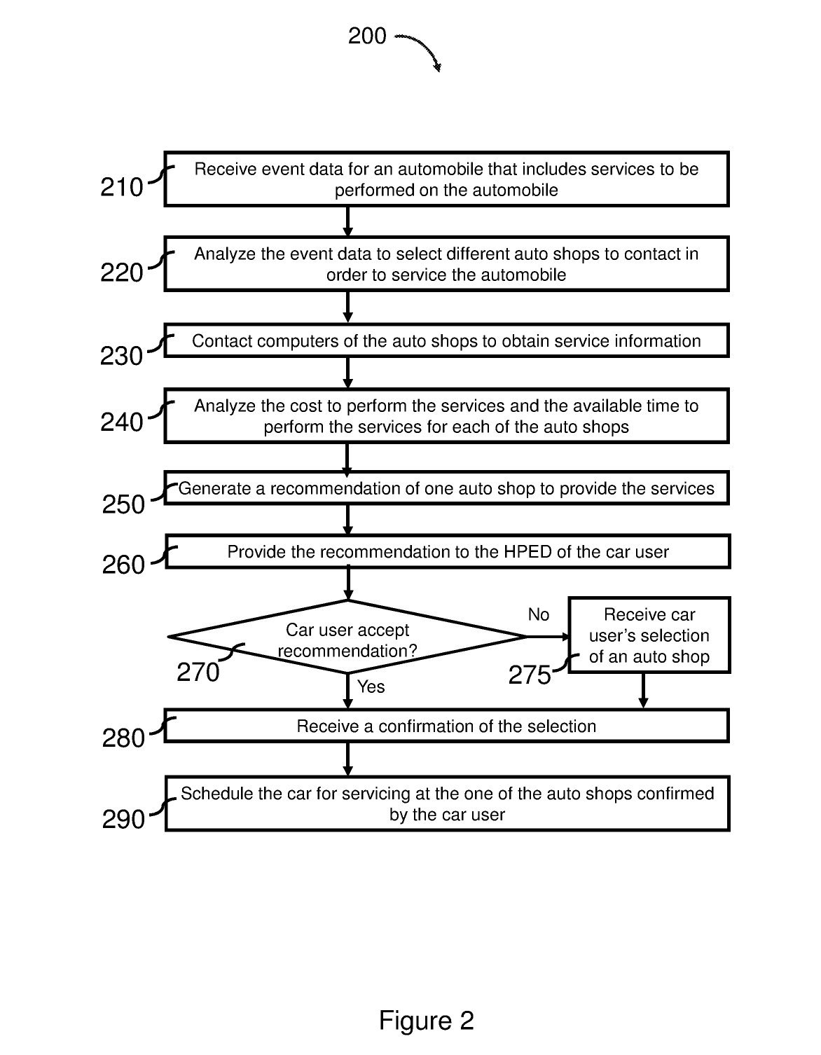

FIG. 2 shows a method of providing a recommendation of an auto shop to an automobile user.

Event data for an automobile includes services to be performed on the automobile is received in block 210.

As one example, an event data can include a picture of an automobile after the automobile is in a car accident, diagnostic data of damage to an automobile, a service to be performed on the car, data of regular exam, a problem code that is generated from a sensor in the car, etc.

By way of example, a service to be performed in an automobile includes changing engine oil, replacing filters (air filter, oil filter, fuel filter, etc.), tuning engine, replacing broken or malfunctioning part, checking and refilling level of brake fluid, checking brake pads/liners/discs, checking condition of tires, checking status of battery, washing/waxing vehicle, etc.

The event data is analyzed to select different auto shops to contact in order to service the automobile in block 220. Computers of the auto shops are contacted to obtain service information in block 230.

By way of example, the service information includes a cost to perform the services on the automobile, an available time to perform the services on the automobile, an impact, etc.

The cost to perform the services and the available time to perform the services for each of the auto shops are analyzed in block 240. A recommendation of one auto shop to provide the services, based on analysis of the cost to perform the services and the available time to perform the services, is generated in block 250.

The recommendation as to one of the auto shops to provide the services on the automobile is provided to the HPED of the car user in block 260. If the car user accepts the recommendation in block 270, a confirmation of the selection is received in block 280. The car for servicing at the one of the auto shops confirmed by the car user is scheduled in block 290.

In one example embodiment, if the car user does not accept the recommendation in block 270, a car user's selection of an auto shop is received in block 275. A confirmation of the selection is received in block 280. The car for servicing at the one of the auto shops confirmed by the car user is scheduled in block 290.

By way of example, the auto shops are ranked by the server in the computer system based on factors such as price quotes for the cost to perform the services, the available time to perform the services, a distance to the auto shops, customer feedback, and a duration of time to complete the services.

In one example, scores for each of the auto shops are generated by the server in the computer system based on the cost to perform the services and the available time to perform the services for each of the auto shops. The scores, in a hierarchical list that orders the auto shops from a highest score to a lowest score, are sent by the server in the computer system and to the HPED of the automobile user.

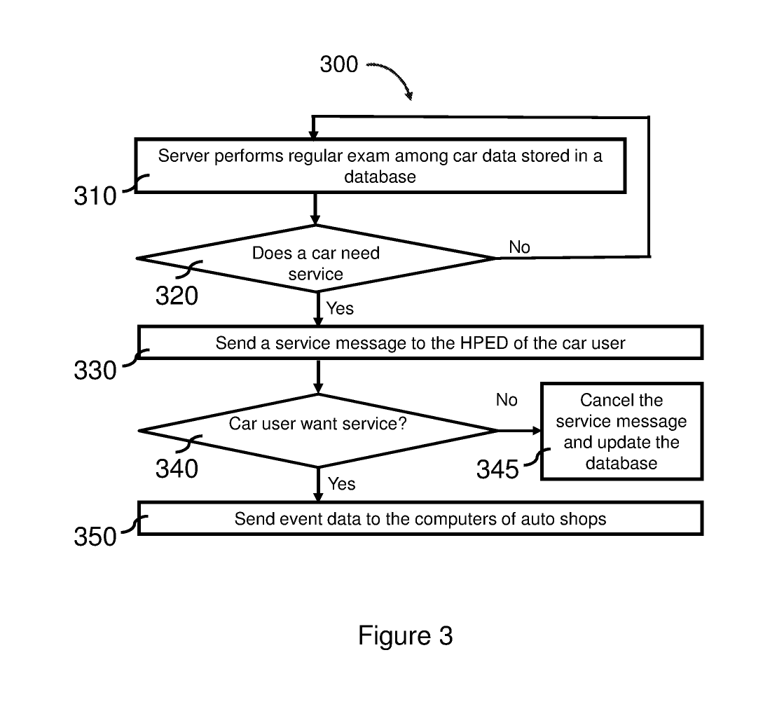

FIG. 3 shows a method of regular exam on an automobile initiated by a server. The server performs a regular exam among car data stored in a database in block 310. If the car needs a service in block 320, a service message is sent to the HPED of the car user in block 330. If the car user wants to have the service in block 340, an event data is sent to the computers of auto shops in block 350.

In an example embodiment, if the car does not need a service in block 320, the server will continue to perform regular exam among car data stored in a database in block 310, until a car service is needed.

By way of example, if the car user does not want to have the service in block 340, the service message is canceled and the database is updated in block 345.

In one example embodiment, a regular exam can be performed in which diagnostic data of various parts of the car are collected periodically to assess the status of the car.

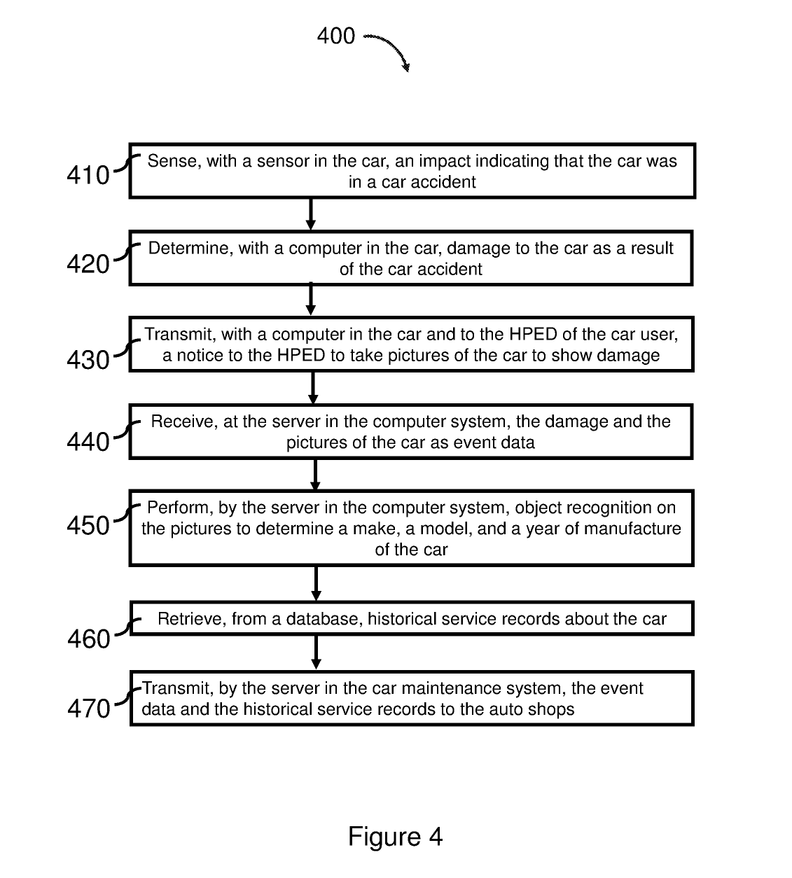

FIG. 4 shows a method of communicating with an auto shop upon a car accident. An impact indicating that the car is in a car accident is sensed with a sensor in the car in block 410. The damage to the car as a result of the car accident is determined with a computer in the car in block 420.

By way of example, the damage to the car as the event data is transmitted to the server with the computer in the automobile.

A notice to the HPED to take pictures of the car to show damage is transmitted to the HPED of the car user with a computer in the car in block 430. The damage and the pictures of the car as event data are received at the server in the computer system in block 440. In one example embodiment, the pictures of the automobile as the event data are transmitted to the auto shops with the server in the computer system.

Object recognition on the pictures determines a make, a model, and a year of manufacture of the car is performed by the server in the computer system in block 450. By way of example, the make, the model, and the year are compared by the server in the computer system with owner data to verify a name of an owner of the automobile.

Historical service records about the car are retrieved from a database in block 460. The event data and the historical service records are transmitted to the auto shops by the server in the car maintenance system in block 470. In one example embodiment, the pictures, the make, the model, the year, and the name of the owner are transmitted with the server in the computer system to the auto shops.

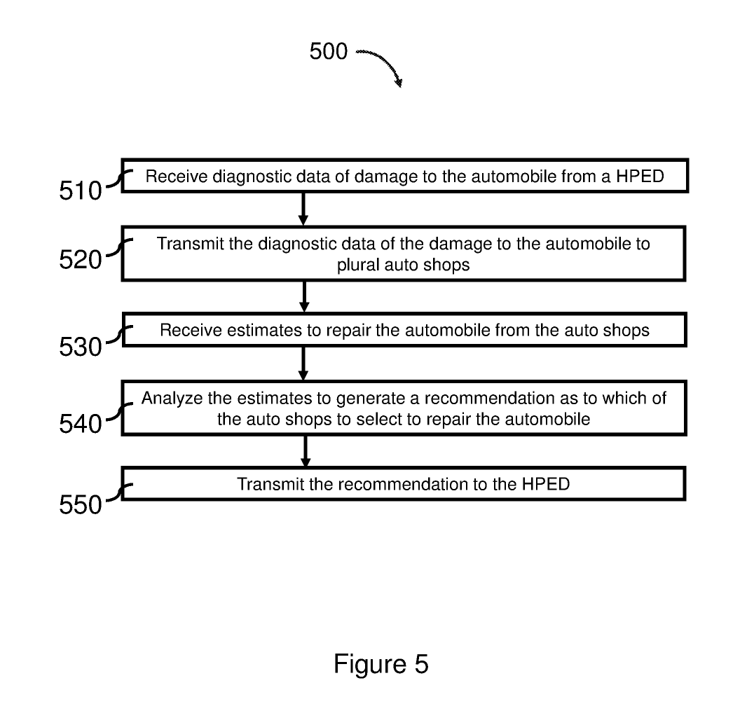

FIG. 5 shows a method of providing a recommendation of an auto shop to a HPED upon a car accident. Diagnostic data of damage to the automobile from a HPED is received by a server in the computer system in block 510. The diagnostic data of the damage to the automobile is transmitted to plural auto shops in block 520. Estimates to repair the automobile from the auto shops are received by the server in block 530. The estimates are analyzed by the server to generate a recommendation as to which of the auto shops to select to repair the automobile in block 540. The recommendation is transmitted to the HPED in block 550.

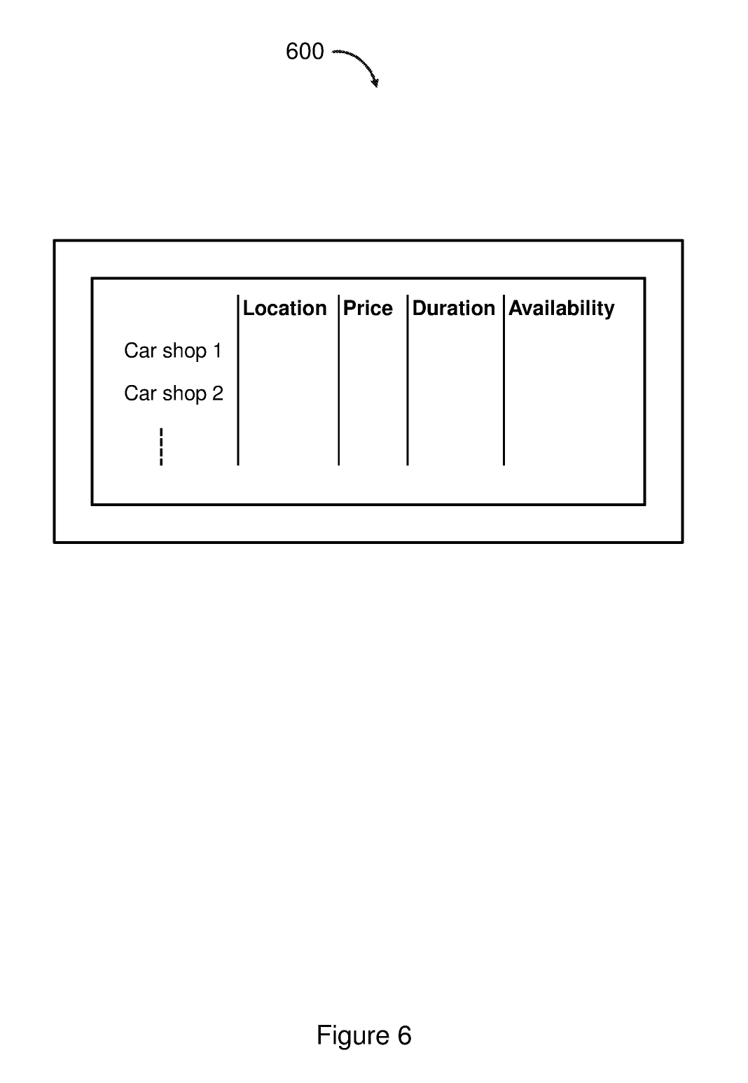

FIG. 6 shows a display of a HPED 600. A list of auto shops with details such as a distance from the automobile, a price to repair the automobile, a duration of time to repair the automobile, and an available time to perform the services on the automobile is shown in the display of the HPED. By way of example, other attributes such as a location of the auto shop, a start date to repair the automobile, and a rank of the auto shops can be shown on the display of the HPED.

By way of example, the auto shops can be listed in a priority according to scores of the auto shops. In one example embodiment, the scores are generated based on a cost to perform the services and the available time to perform the services.

As used herein, a “repair” is not restricted to be interpreted to fixing a broken part, but also includes the meaning of replacing or substituting a malfunctioning part, a worn out part, or inoperative part with a functioning or operative part.

What is claimed is:

1. A method executed by a computer system to recommend an auto shop to an automobile user, the method comprising:
receiving, at a server in the computer system, event data for an automobile that includes services to be performed on the automobile;
analyzing, by the server in the computer system, the event data to select different auto shops to contact in order to service the automobile;
contacting, by the server in the computer system, computers of the auto shops to obtain service information that includes a cost to perform the services on the automobile and an available time to perform the services on the automobile;
analyzing, by the server in the computer system, the cost to perform the services and the available time to perform the services for each of the auto shops;
generating, by the server in the computer system and based on the analyzing of the cost to perform the services and the available time to perform the services, a recommendation as to one of the auto shops to provide the services on the automobile; and
providing, by the server in the computer system and to a handheld portable electronic device (HPED) of the automobile user, the recommendation as to one of the auto shops to provide the services on the automobile.

2. The method of claim 1 further comprising:
ranking, by the server in the computer system, the auto shops based on price quotes for the cost to perform the services, the available time to perform the services, a distance to the auto shops, and a duration of time to complete the services.

3. The method of claim 1 further comprising:
generating, by the server in the computer system, scores for each of the auto shops based on the cost to perform the services and the available time to perform the services for each of the auto shops; and
sending, by the server in the computer system and to the HPED of the automobile user, the scores in a hierarchical list that orders the auto shops from a highest score to a lowest score.

4. The method of claim 1 further comprising:
sensing, with a sensor in the automobile, an impact indicating that the automobile was in a car accident;
determining, with a computer in the automobile, damage to the automobile as a result of the car accident; and
transmitting, with the computer in the automobile and to the server, the damage to the car as the event data.

5. The method of claim 1 further comprising:
receiving, at the server in the computer system, pictures of the automobile after the automobile is in a car accident; and
transmitting, with the server in the computer system and to the auto shops, the pictures of the automobile as the event data.

6. The method of claim 1 further comprising:
sensing, with a sensor in the automobile, an impact indicating that the automobile was in a car accident; and
transmitting, with a computer in the automobile and to the HPED of the automobile user, a notice to take pictures of the automobile to show damage that the automobile sustained in the car accident.

7. The method of claim 1 further comprising:
receiving, at the server in the computer system, the event data that includes pictures of the automobile after the automobile was in a car accident;
performing, by the server in the computer system, object recognition on the pictures to determine a make, a model, and a year of manufacture of the automobile;
comparing, by the server in the computer system, the make, the model, and the year with owner data to verify a name of an owner of the automobile; and
transmitting, with the server in the computer system and to the auto shops, the pictures, the make, the model, the year, and the name of the owner.

8. A computer system, comprising:
a sensor in an automobile that detects an impact when the automobile is in a collision;
a computer in the automobile that determines diagnostic data of damage to the automobile after the sensor detects the collision;
a handheld portable electronic device (HPED) that communicates with the computer and receives the diagnostic data of the damage to the automobile; and
a server with an auto shop recommender that receives the diagnostic data of the damage to the automobile from the HPED, transmits the diagnostic data of the damage to the automobile to plural auto shops, receives estimates to repair the automobile from the auto shops, analyzes the estimates to generate a recommendation as to which of the auto shops to select to repair the automobile, and transmits the recommendation to the HPED.

9. The computer system of claim 8, wherein the auto shop recommender receives photographs of the automobile from the HPED, executes object recognition on the photographs to determine a make, a model, and a year of the automobile, and compares the make, the model, and the year of the automobile to stored owner data to verify an owner of the automobile.

10. The computer system of claim 8, wherein the auto shop recommender generates ranks of the auto shops according to distance from the automobile, price to repair the automobile, length of time to repair the automobile, and a start date to repair the automobile, and wherein the auto shop recommender provides the ranks to the HPED.

11. The computer system of claim 8, wherein the auto shop recommender transmits a reminder to the HPED to take photographs of the automobile after the collision.

12. The computer system of claim 8, wherein auto shop recommender scores the auto shops and provides the scores to the HPED with the recommendation, and wherein the HPED receives the recommendation and displays a list of the auto shops in a priority according to the scores.

13. A method executed by a car maintenance system to provide a recommendation to a car user, the method comprising:
receiving, by a server in the car maintenance system and from the car, position data and event data that includes a service to be performed on the car;
transmitting, by the server in the car maintenance system, the event data to a plurality of auto shops;
receiving, by the server in the car maintenance system and from the auto shops, service data that includes a price to perform the service on the car;
ranking, by the server in the car maintenance system, the auto shops based on an analysis of the service data that includes the price to perform the service on the car;
providing, by the server in the car maintenance system and to car user, a recommendation of one of the auto shops based on the ranking of the auto shops by the server;
receiving, by the server in the car maintenance system and from the car user, a confirmation of the recommendation of the one of the auto shops; and
scheduling, by the server in the car maintenance system, the car for servicing at the one of the auto shop confirmed by the car user.

14. The method of claim 13 further comprising:
capturing an image with a handheld portable electronic device (HPED);
determining, by the HPED and using object recognition, that the image is an image of the car; and
transmitting, by the HPED, the image of the car to the server.

15. The method of claim 13 further comprising:
retrieving, by the server in the car maintenance system and from a database, historical service records about the car;
transmitting, by the server in the car maintenance system, the event data and the historical service records to the auto shops.

16. The method of claim 13 further comprising:
determining, by the server in the car maintenance system, a time when the car is involved in a collision; and
sending, by the server in the car maintenance system, a reminder to take a photograph of the car after a predetermined amount of time elapses from the time when the car is involved in the collision.

17. The method of claim 13, wherein the event data includes a problem code that is generated from a sensor in the car.
